(19) United States
(12) Patent Application Publication
(10) Pub. No.: US 2010/0174398 A1
(43) Pub. Date: Jul. 8, 2010

(54) POSITION MEASURING APPARATUS AND COATING APPARATUS

(75) Inventors: Taizan Kobayashi, Kawasaki (JP); Yukio Ozaki, Kawasaki (JP); Toshinori Kasuga, Kawasaki (JP); Yasuyuki Masuda, Kawasaki (JP); Nobuaki Kawashima, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/651,879

(22) Filed: Jan. 4, 2010

(30) Foreign Application Priority Data
Jan. 8, 2009 (JP) 2009-2936

(51) Int. Cl. B25J 13/08; G01C 3/00; G06F 17/00

(52) U.S. Cl. 700/114; 356/3.03; 700/258; 901/46

(57) ABSTRACT

A position measuring apparatus includes a distance measuring part which obtains at least three pieces of distance information between at least three measurement points on a measured plane of an object and a displacement sensor, an imaging part which images a projection image on the measured plane of the object, and a calculating part which obtains tilt information of the measured plane based on the at least three distance information pieces and obtains position information of the object based on the tilt information and the projection image.

### CROSS-REFERENCE TO RELATED APPLICATIONS

This application is related to and claims priority to Japanese Patent Application No. 2009-2936, filed on Jan. 8, 2009, and incorporated herein by reference.

### FIELD

The embodiments discussed herein are related to a position measuring apparatus and a coating apparatus.

### BACKGROUND

A process for processing a substrate held by a substrate holder includes a continuous film-formation method. In the continuous film-formation method, a substrate under conveyance is subjected to film-formation processing in a chamber while being sequentially conveyed, and a magnetic film is deposited on the substrate. In a semiconductor wafer film-formation process, the film-formation processing may be applied to only one side of the substrate; however, in the production of a magnetic disk, since the film-formation processing is applied to both sides of the substrate, the continuous film-formation method is useful.

In the continuous film-formation method, a supply robot is used, and a substrate is held by a holding claw of a substrate holder mounted on a conveyance mechanism (a carrier). Since the substrate holder moves in a chamber in which the film-formation processing is performed, a film-formation layer is adhered to the holding claw. When the substrate is held by this holding claw, if the center of the holding claw and the center of the substrate do not coincide, the substrate tends to shift to a stable posture so as to follow the center of the holding claw. When that happens, the film-formation layer adhered to the holding claw is ground by the peripheral edge of the substrate. The adhesion of the ground film-formation layer to the substrate causes a defect of the film-formation processing, leading to a reduction of yield. When the accuracy of the supply position and supply posture of the substrate which is supplied to the substrate holder by the supply robot is poor, the substrate may be dropped, whereby the operating rate may be possibly reduced.

In order to avoid the above problems, the substrate is required to be supplied to the substrate holder with high accuracy. In order to supply the substrate to the substrate holder with high accuracy, the posture and position of the substrate are accurately determined. In the prior art, various apparatuses considered to address this problem have been proposed. In Japanese Laid-open Patent Publication No. 11-265967, a position of a movable member in a substrate conveying system such as a substrate processing apparatus is detected and monitored.

### SUMMARY

According to an aspect of the invention, a position measuring apparatus includes a distance measuring part which obtains at least three pieces of distance information between at least three measurement points on a measured plane of an object and a displacement sensor, an imaging part which images a projection image on the measured plane of the object, and a calculating part which obtains tilt information of the measured plane based on the at least three distance information pieces and obtains position information of the object based on the tilt information and the projection image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view showing a schematic constitution of a coating apparatus of an embodiment;

FIG. 2 is an explanatory view showing the periphery of a supply robot 300 of the coating apparatus;

FIG. 3 is an explanatory view of a substrate holder;

FIG. 4 is a flow diagram for explaining a substrate holding process performed by the supply robot;

FIGS. 5A, 5B, and 5C are explanatory views showing a state of a substrate in the substrate holding process;

FIG. 6 is an explanatory view showing a flow of a film-formation method performed in the coating apparatus;

FIG. 7 is an explanatory view schematically showing a position measuring apparatus;

FIG. 8 is a block diagram showing an example of the constitution of the position measuring apparatus;

FIG. 9 is a perspective view of a first displacement sensor, a second displacement sensor, a third displacement sensor, and the substrate holder;

FIGS. 10A and 10B are explanatory views showing a relationship between the first displacement sensor, the second displacement sensor, the third displacement sensor and a loader chamber, FIG. 10A is an outside perspective view of the loader chamber, and FIG. 10B is an inside view of the loader chamber;

FIG. 11 is an explanatory view showing a positional relationship between the first displacement sensor, the second displacement sensor, the third displacement sensor, and the substrate holder;

FIG. 12 is a perspective view of the first displacement sensor, the second displacement sensor, the third displacement sensor and an image sensor;

FIG. 13 is a flow diagram showing a position teaching method for the supply robot;

FIG. 14 is a flow diagram of a position measurement process for the substrate;

FIG. 15 is an explanatory view showing calculation of tilt information in the position measurement process for the substrate;

FIGS. 16A and 16B are explanatory views of a projection image taken by the image sensor;

FIG. 17 is a graph showing a part of a measurement result of the tilt information and position information;

FIG. 18 is a flow diagram of the position measurement process for the substrate when a triangulation method is used;

FIG. 19 is an explanatory view of a measurement principle of a displacement sensor using the triangulation method;

FIG. 20 is an explanatory view of calculation of a light entering position on the displacement sensor using the triangulation method;

FIG. 21 is an explanatory view of a position coordinate in a light receiving window of the displacement sensor; and

FIG. 22 is a view of an example of a table collecting correction values based on a specularly reflected light position for the light receiving window.

### DESCRIPTION OF EMBODIMENTS

In order to know the accurate state of a substrate held by a substrate holder, information about a total of six degrees of freedom, the position in X direction, the position in Y direction, the position in Z direction, tilt around X-axis, tilt around Y-axis, and tilt around Z-axis is required.

However, in the prior proposal, information of only three degrees of freedom can be obtained, and therefore, it is unsatisfactory to obtain accurate information regarding the substrate. It was considered to provide a plurality of apparatuses in the prior proposal and perform measurement from different directions, whereby information about many degrees of freedom is obtained. However, such a measurement is difficult because the substrate holder is conveyed in sequence in a chamber.

Further, since the substrate holder moves in a vacuum chamber, a non-contact measurement is required. Therefore, the state of the substrate in the chamber is measured through a chamber window provided in the outer wall of the chamber. However, the chamber window is normally provided in only one face of the chamber. Especially, in a loader chamber in which a disk-shaped substrate is held by the substrate holder, the movement of the carrier and the retraction of the supply robot should be secured, and therefore, it is difficult to provide the chamber windows in a plurality of faces of the chamber. Due to this reason, it is difficult to perform the measurement from different directions.

The present embodiment has been made in view of the above problems, and it is an object of the embodiment to obtain position information of an object with high accuracy by measurement from one direction.

A position measuring apparatus, a film-formation method, a film-formation program, and a coating apparatus will be described with reference to the drawings. The present embodiments are realized by a computer program executed on a computer used for versatile purposes, such as a personal computer and a workstation. The computer program is stored in a portable medium such as a flexible disk and a CD-ROM, a main memory of another network-connected computer, or an auxiliary storage device are provided. The computer program of the embodiment from a portable medium is directly loaded to a main memory of a computer to be executed. In a computer provided with an auxiliary storage device, the computer program from the portable medium is temporarily copied or installed in the auxiliary storage device to be thereafter loaded in a main memory, and, thus, to be executed.

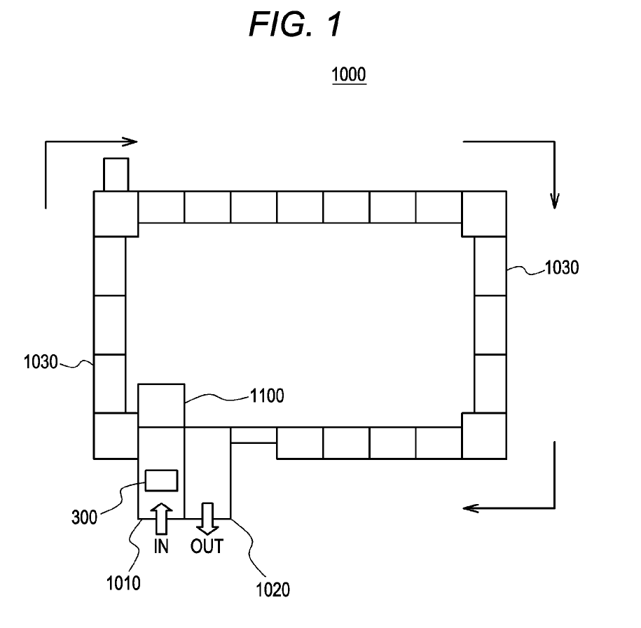

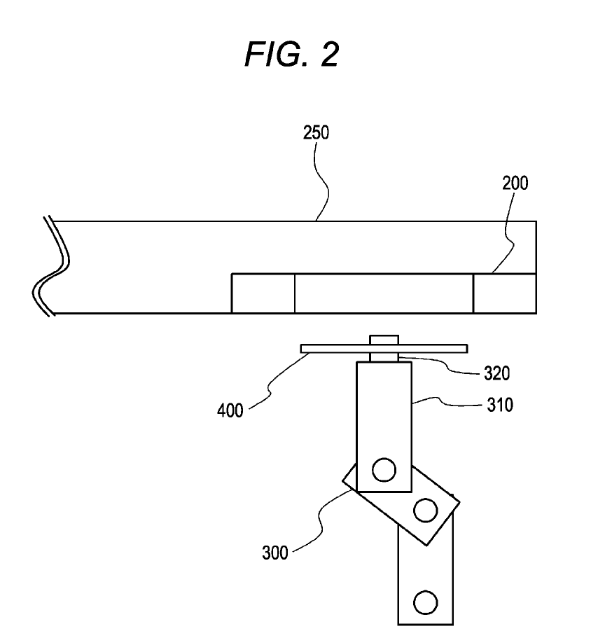

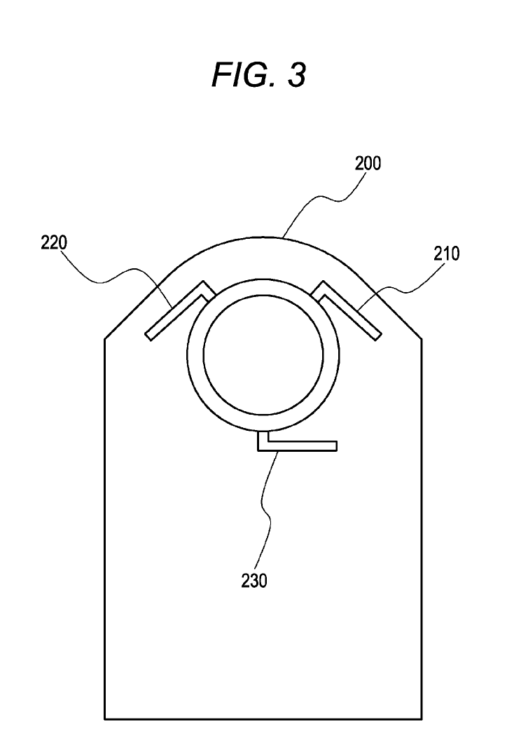

FIG. 1 is an explanatory view showing a schematic constitution of a coating apparatus 1000 of an embodiment. FIG. 2 is an explanatory view showing the periphery of a supply robot 300 of the coating apparatus 1000. FIG. 3 is an explanatory view of a substrate holder 200.

The coating apparatus 1000 is provided with the supply robot 300, the substrate holder 200, a loader chamber 1010, an unloader chamber 1020, and a plurality of film-formation chambers 1030. The coating apparatus 1000 is further provided with a position measuring apparatus 1100 using a substrate 400 as an object.

The substrate 400 before film-formation processing is conveyed by the supply robot 300 in the loader chamber 1010 and held by the substrate holder 200. The loader chamber 1010 is connected to the film-formation chamber 1030 provided at one end of a plurality of the connected film-formation chambers 1030. A plurality of the film-formation chambers 1030 are circularly arranged, and the film-formation processing is applied to the substrate 400 in the film-formation chambers 1030. The film-formation chamber 1030 provided at the other end of a plurality of the connected film-formation chambers 1030 is connected to the unloader chamber 1020. In the unloader chamber 1020, the substrate 400 after the film-formation processing is removed from the substrate holder 200 to be conveyed outside the coating apparatus 1000.

The supply robot 300 has an extendable and contractible arm 310 as shown in FIG. 2. The front end of the arm 310 has a pick 320 which is inserted through a hole provided at the center of the disk-shaped substrate 400 and lifts up the substrate 400. The supply robot 300 can move the substrate 400 in the front, back, left, and right directions. The mounting angle of the pick 320 can be adjusted.

The substrate holder 200 is mounted on a carrier 250. The carrier 250 can circulate in sequence in the film-formation chambers 1030. The substrate holder 200 has an upper claw 210 as a first holding claw, an upper claw 220 as a second holding claw, and a lower claw 230 as a third holding claw. The substrate 400 is held by the upper claws 210 and 220 and the lower claw 230. The substrate 400 held by the substrate holder 200 circulates in sequence in a plurality of the film-formation chambers 1030, and the film-formation processing is applied to the substrate 400 in each of the film-formation chambers 1030.

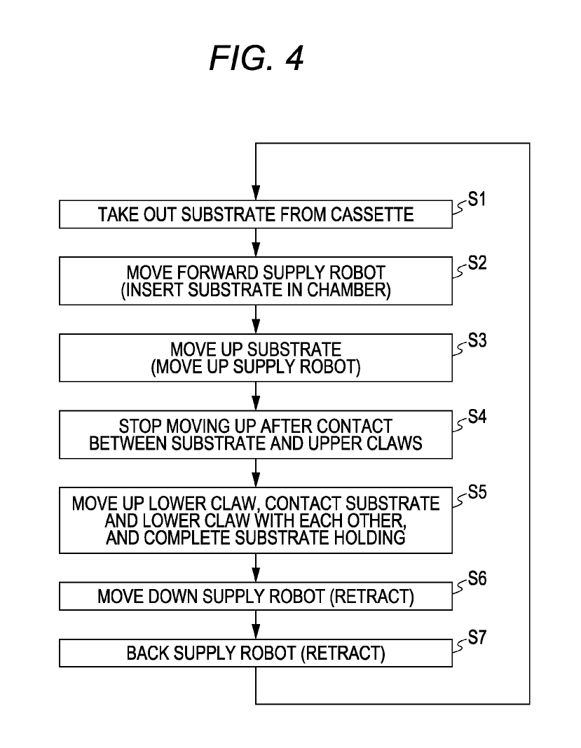

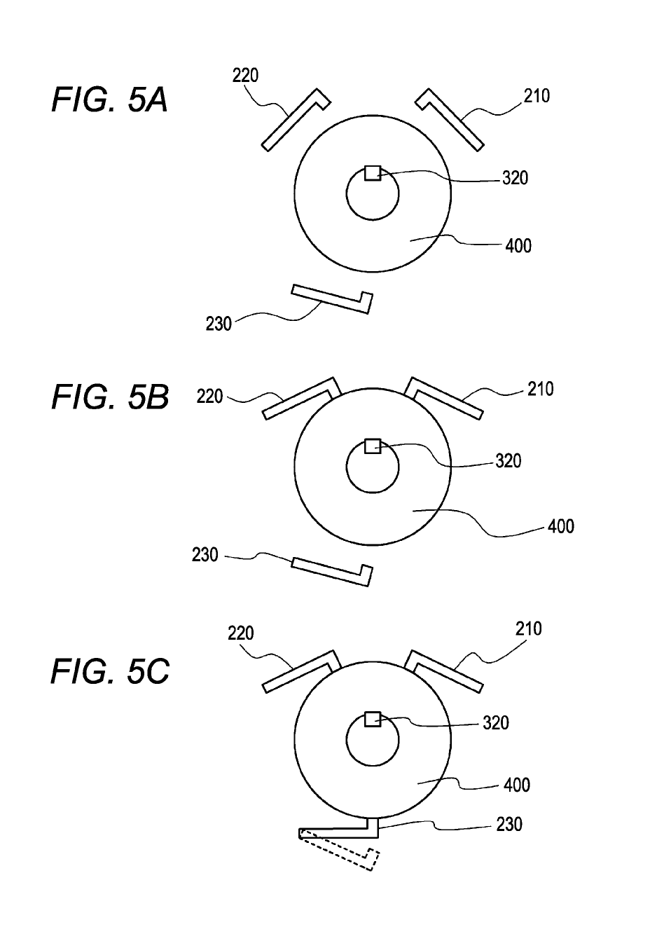

FIG. 4 is a flow diagram for explaining a substrate holding process performed by the supply robot 300. FIG. 5 is an explanatory view showing a state of the substrate 400 in the substrate holding process. First, in step S1, the supply robot 300 takes out the substrate 400 from a cassette (stacker) in which a large number of the substrates 400 are stacked (step S1). The substrate 400 is lifted up by the pick 320 and then moved. Thereafter, in step S2, the supply robot 300 moves forward and inserts the substrate 400 into the loader chamber 1010. As shown in FIG. 5A, the substrate 400 is supplied into a region surrounded by the upper claws 210 and 220 and the lower claw 230.

Next, in step S3, as shown in FIG. 5B, the substrate 400 is moved up so as to be pressed against the upper claws 210 and 220. Then, in step S4, after confirmation of the contact between the substrate 400 and the upper claws 210 and 220, the moving up of the pick 320 is stopped. Thereafter, in step S5, as shown in FIG. 5C, the lower claw 230 is moved up, and the substrate 400 and the lower claw 230 are in contact with each other. According to this constitution, the holding of the substrate 400 by the substrate holder 200 is completed. After the completion of the holding of the substrate 400, the supply robot 300 moves down the pick 320 in step S6. Subsequently, the supply robot 300 is retracted in step S7, and operation is terminated. The supply robot 300 returns to step S1 again and starts the next substrate holding process for the substrate 400.

During the substrate holding process for the substrate 400, the position measuring apparatus 1100 continuously performs the position measurement for the substrate 400.

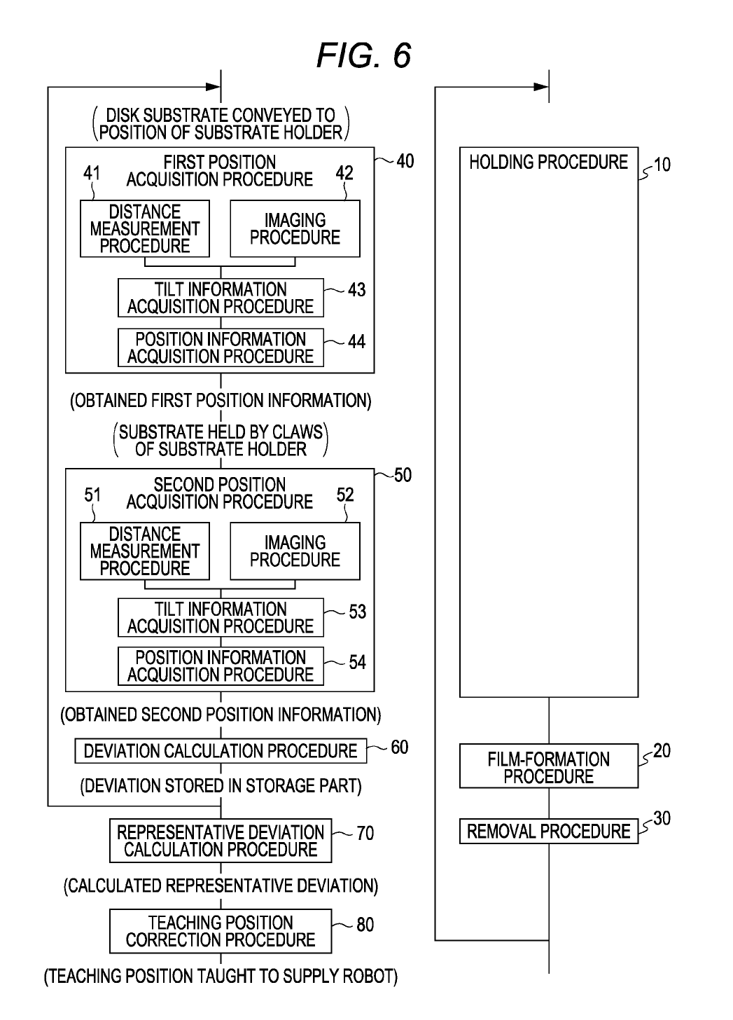

FIG. 6 is an explanatory view showing a flow of a film-formation method performed in the coating apparatus 1000. The film-formation method performed in the coating apparatus 1000 has a holding procedure 10, a film-formation procedure 20, and a removal procedure 30. This method further has a method for teaching the position of the substrate 400. The position teaching method has a first position information storage procedure 40, a second position information recording procedure 50, a deviation calculation procedure 60, a representative deviation calculation procedure 70, and a teaching position correction procedure 80. In FIG. 6, the state before the procedure and the state after the procedure are shown before and after each of the procedures. The contents of each procedure are shown as follows.

In the holding procedure 10, as described above with reference to FIGS. 4 and 5, the disk-shaped substrates 400 conveyed by the supply robot 300 are held in sequence by a plurality of the substrate holders 200.

In the film-formation procedure 20, the substrate 400 held by the substrate holder 200 is moved into a plurality of the film-formation chambers 1030 in sequence to be subjected to the film-formation processing in each of the film-formation chambers 1030.

In the removal procedure 30, the substrate 400 after the film-formation process is removed from the substrate holder 200 by a robot.

In the first position information storage procedure 40, the supply robot 300 conveys the substrate 400 in a vertical state to a predetermined position of the substrate holder 200 that has been previously taught as a supply position, and the center position of the substrate 400 at the supply position is recorded as first position information from the position measuring apparatus 1100 to be described later.

The first position information storage procedure 40 further includes a distance measurement procedure 41, an imaging procedure 42, a tilt information acquisition procedure 43, and a position information acquisition procedure 44.

In the distance measurement procedure 41, the distance in the horizontal direction is measured with respect to three measurement points 400a1, 400a2, and 400a3 on a measured plane 400a of the substrate 400.

In the imaging procedure 42, a projection image of the measured plane 400a of the substrate 400 is imaged as viewed from the horizontal direction.

In the tilt information acquisition procedure 43, the tilt information (tilts α and γ to be described later) of the measured plane 400a is obtained based on the distance in the horizontal direction.

In the position information acquisition procedure 44, the position information of the substrate 400 is obtained based on the tilt information and the projection image.

In the second position information recording procedure 50, the substrate 400 is mounted to the substrate holder 200 in the supply position, and the center position of the substrate 400 mounted to the substrate holder 200 is recorded as the second position information from the position measuring apparatus 1100.

The second position information recording procedure 50 further has a distance measurement procedure 51, an imaging procedure 52, and a tilt information acquisition procedure 53, and a position information acquisition procedure 54.

In the distance measurement procedure 51, the distance in the horizontal direction is measured with respect to the three measurement points 400a1, 400a2, and 400a3 on the measured plane 400a of the substrate 400.

In the imaging procedure 52, the projection image of the measured plane 400a of the substrate 400 is imaged as viewed from the horizontal direction.

In the tilt information acquisition procedure 53, the tilt information (the tilts α and γ to be described later) of the measured plane 400a is obtained based on the distance in the horizontal direction.

In the position information acquisition procedure 54, the position information of the substrate 400 is obtained based on the tilt information and the projection image.

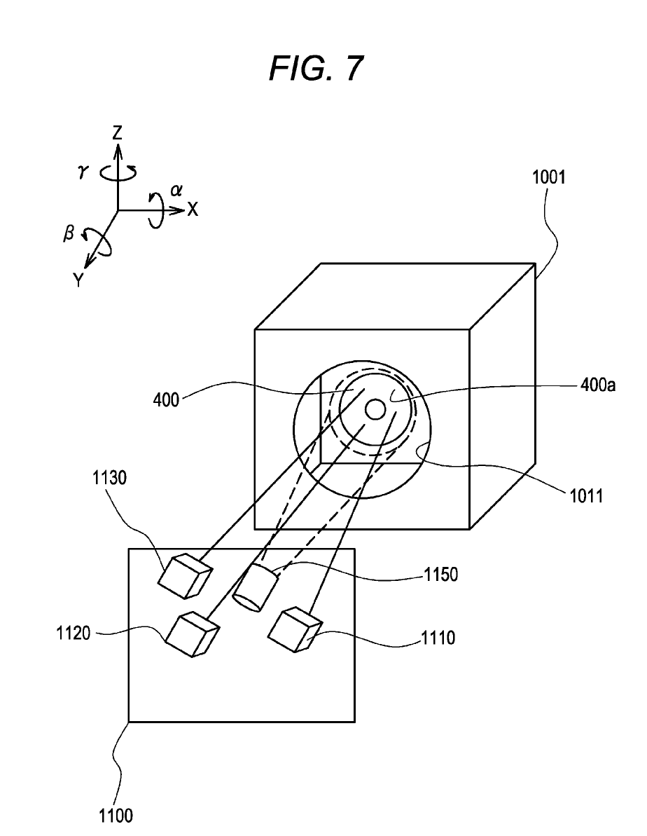

In the deviation calculation procedure 60, a deviation which is a difference between the first position information and the second position information is obtained and stored in a substrate position data storage part 1250 (see, FIG. 7).

In the representative deviation calculation procedure 70, the first position acquisition procedure, the second position acquisition procedure, and the deviation calculation procedure are applied to a plurality of substrate holders, and a representative deviation representing a deviation is calculated from a plurality of deviations, stored in the substrate position data storage part 1250, by a predetermined calculation method.

In the teaching position correction procedure 80, the teaching position obtained by correcting the supply position based on the representative deviation is taught to the supply robot 300.

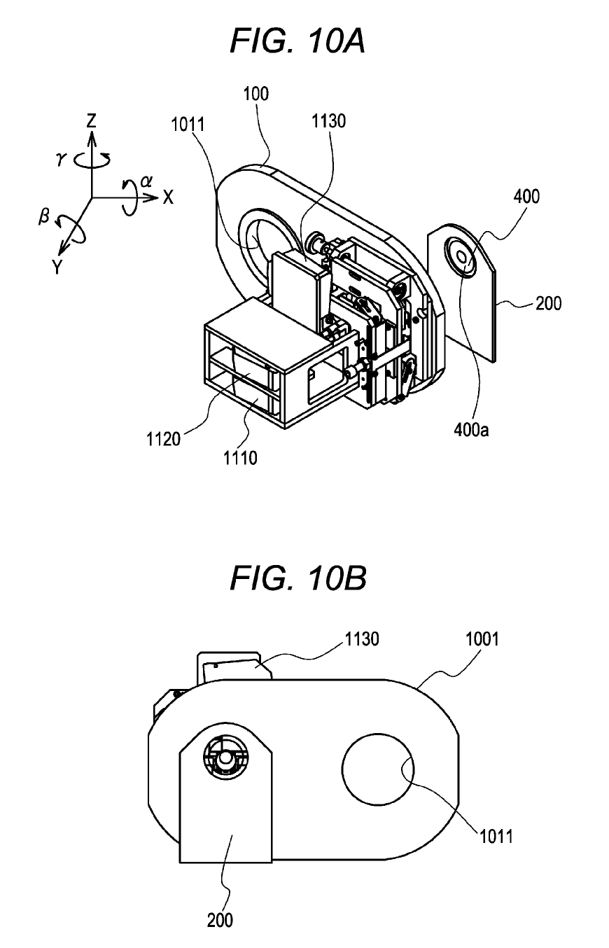

In the loader chamber 1010, the substrate 400 is held by the substrate holder 200 as described above. Therefore, the supply robot 300 is disposed on the front side of the loader chamber 1010. As shown in FIG. 10, a chamber window 1011 is provided in the outside wall facing the face disposed with the supply robot 300.

The coating apparatus 1000 is provided with the position measuring apparatus 1100 performing the position measurement for the substrate 400 through the chamber window 1011. FIG. 7 is an explanatory view schematically showing the position measuring apparatus 1100. The position measuring apparatus 1100 grasps the position of the substrate 400 in the first and second position acquisition procedures in the position teaching method shown in FIG. 6.

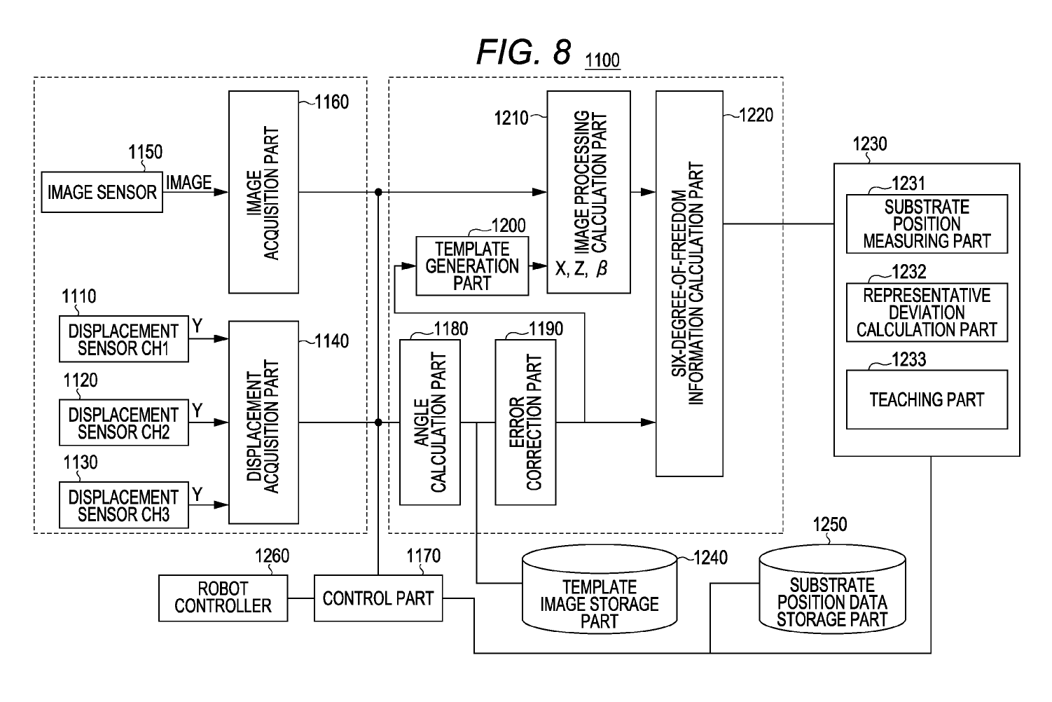

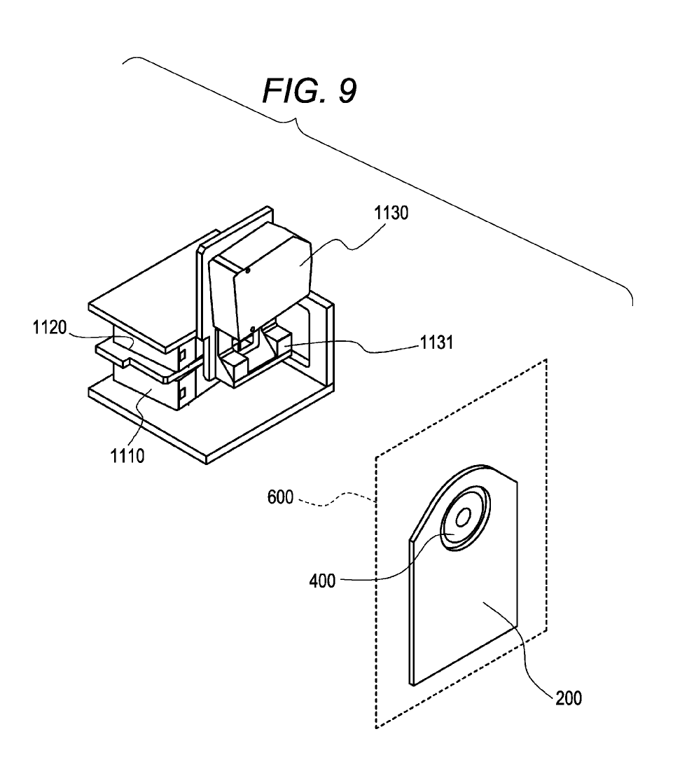

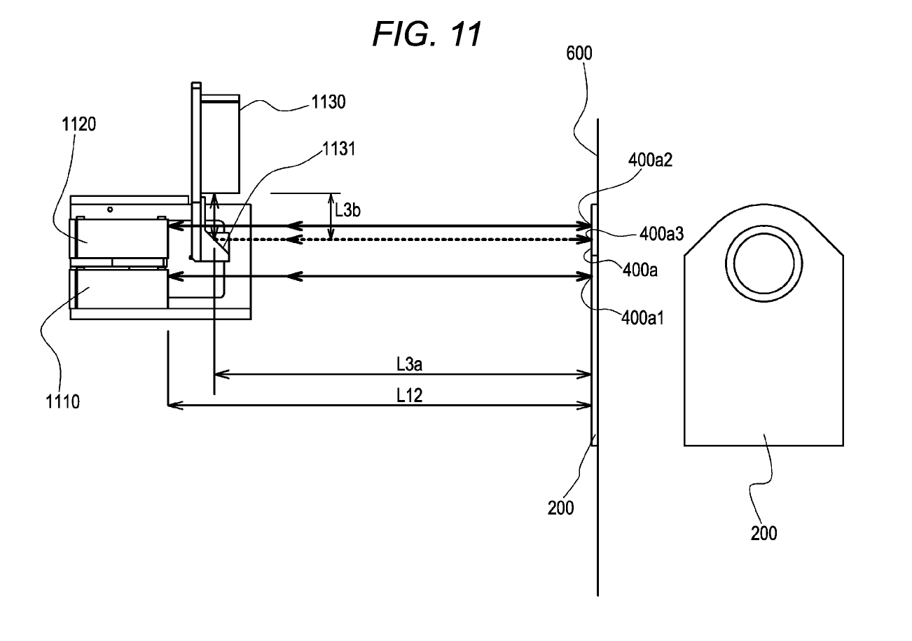

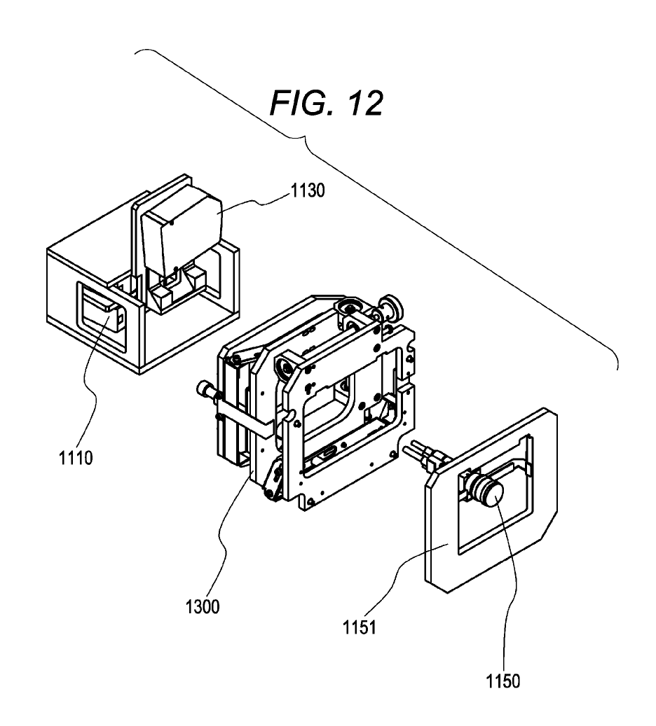

FIG. 8 is a block diagram showing an example of the constitution of the position measuring apparatus 1100. FIG. 9 is a perspective view of a first displacement sensor 1110, a second displacement sensor 1120, a third displacement sensor 1130, which are included in the position measuring apparatus 1100, and the substrate holder 200. FIG. 10 is an explanatory view showing a relationship between the first displacement sensor 1110, the second displacement sensor 1120, the third displacement sensor 1130 and the loader chamber 1010. FIG. 10A is an outside perspective view of the loader chamber 1010, and FIG. 10B is an inside view of the loader chamber 1010. FIG. 11 is an explanatory view showing a positional relationship between the first displacement sensor 1110, the second displacement sensor 1120, the third displacement sensor 1130 and the substrate holder 200. FIG. 12 is a perspective view of the first to third displacement sensors 1110 to 1130 and an image sensor 1150.

The position measuring apparatus 1100 is provided with a distance measuring unit, which measures the distance in the horizontal direction to each of the three measurement points 400a1, 400a2, and 400a3 on the measured plane 400a of the substrate 400 as an object. The distance measuring unit has the three displacement sensors 1110, 1120, and 1130. Those displacement sensors 1110, 1120, and 1130 measure the distance to each of the measurement points by application of a laser beam. The first displacement sensor 1110 corresponds to the first measurement point 400a1. The second displacement sensor 1120 corresponds to the second measurement point 400a2. The third displacement sensor 1130 corresponds to the third measurement point 400a3. Those displacement sensors 1110, 1120, and 1130 are arranged so as to face a vertical virtual plane 600 shown in FIGS. 9 and 11. The vertical virtual plane 600 is such a virtual plane that when a horizontal laser beam is applied from different positions in the same plane, the optical distances to the plane are equal to each other.

The displacement sensors 1110, 1120, and 1130 are arranged so that when the measured plane 400a is in a state of being parallel to the vertical virtual plane 600, the optical distances to the measurement points 400a1, 400a2, and 400a3 are equal to each other. The optical distance is a distance in a depth direction (Y direction) of the substrate 400.

The first and second displacement sensors 1110 and 1120 are arranged so as to overlap above and below each other. As shown in FIG. 11, the distance between the first displacement sensor 1110 and the first measurement point 400a1 can be displayed as a distance L12. Likewise, the distance between the second displacement sensor 1120 and the second measurement point 400a2 can be displayed as the distance L12.

Meanwhile, the third displacement sensor 1130 is provided in a state of being rotated 90° with respect to the first and second displacement sensors 1110 and 1120 and has a prism 1131. The laser beam emitted from the third displacement sensor 1130 is bent by the prism 1131 to reach the third measurement point 400a3. The distance where the laser beam emitted from the third displacement sensor 1130 reaches the third measurement point 400a3 is the sum of a distance L3a from the third measurement point 400a3 to the prism 1131 and a distance L3b from the third displacement sensor 1130 to the prism 1131. The sum of the distances L3a and L3b is set to be equal to the distance L12. The distances from the three displacement sensors to the object are made to coincide with each other, and the installation angles of the three displacement sensors are made to coincide with each other, whereby when the measurement is calculated with difference information, a procedure error can be offset.

The third displacement sensor 1130 is in a state of being rotated with respect to the first and second displacement sensors 1110 and 1120, and consequently it is possible to correspond to the size of the chamber window 1011. Namely, if the three displacement sensors are arranged in the up and down directions, it is difficult to pass all the laser beams through the chamber window 1011 depending on the size of the chamber window 1011. The compact arrangement can be realized by virtue of the use of the prism 1131, whereby the correspondence to the measured plane 400a with a small area can be realized.

The distance measuring unit further has a displacement acquisition part 1140 connected to the first displacement sensor 1110, the second displacement sensor 1120, and the third displacement sensor 1130.

The position measuring apparatus 1100 is provided with an imaging unit which images a projection image of the measured plane of the object as viewed from the horizontal direction. As shown in FIG. 8, the imaging unit is provided with the image sensor 1150 and an image acquisition part 1160 connected with the image sensor 1150. As shown in FIG. 12, the image sensor 1150 is supported by a frame 1151 and mounted to a stage member 1300. The distance measuring unit is also attached to the stage member 1300. The stage member 1300 adjusts the positions of the distance measuring unit and the imaging unit. For example when dirt adheres to a portion of the chamber window 1011, the position measurement can be performed to avoid the dirty portion.

The displacement acquisition part 1140 and the image acquisition part 1160 are connected to a control part 1170 controlling the overall operation of the position measuring apparatus 1100. The displacement acquisition part 1140 is connected to an angle calculation part 1180 as shown in FIG. 8. The angle calculation part 1180 is connected to an error correction part 1190. The error correction part 1190 is connected to a template image storage part 1240 and is further connected to a template generation part 1200. The template generation part 1200 is connected to an image processing calculation part 1210. The image processing calculation part 1210 is connected with the image acquisition part 1160. Data related to the projection image imaged by the image sensor 1150 is sent to the image processing calculation part 1210.

The position measuring apparatus 1100 is provided with a six-degree-of-freedom information calculation part 1220. The six-degree-of-freedom information calculation part 1220 is an example of the calculation part of this embodiment and obtains the tilt information of the measured plane 400a based on the distance information obtained by the distance measuring unit. The six-degree-of-freedom information calculation part 1220 further obtains the position information of the substrate 400, which is an object, based on the tilt information and the projection image.

In the coordinate for evaluating the position information of the substrate 400, as shown in FIG. 7, a direction in which the substrate holder 200 moves is determined as an X direction, a direction where the substrate 400 is inserted and removed is determined as a Y direction, and the up and down direction is determined as a Z direction. The position information is represented by the coordinates in those directions. The tilt information is represented by the tilt a around the X-axis, the tilt β around the Y-axis, and the tilt γ around the Z-axis. The tilt β around the Y-axis does not affect the position measurement. This is because the substrate 400 to be subjected to the position measurement has a disk shape, and therefore, even if the substrate 400 rotates, the tilt β is not changed. When the tilt a around the X-axis and the tilt γ around the Z-axis are changed, the substrate 400 deviates from the vertical virtual plane 600. Namely, when the tilts α and γ are changed, the measured plane 400a makes an angle with the vertical virtual plane 600. In the acquisition of the position information of the substrate 400, the tilts α and γ are calculated as the tilt information in the direction of deviating from the vertical virtual plane 600, and the position information is calculated based on these values.

The control part 1170 is connected to the substrate position data storage part 1250. Data related to the position of the substrate 400 is continuously stored in the substrate position data storage part 1250. The position measuring apparatus 1100 is provided with a position teaching program 1230 on a main memory. The position teaching program 1230 functions as the position teaching unit of this embodiment along with a robot controller 1260 connected to the control part 1170.

The six-degree-of-freedom information calculation part 1220 first calculates the tilt information α and γ of the measured plane 400a based on the deviation from the vertical virtual plane 600 on the basis of the distance information obtained by the distance measuring unit.

Then, the position information of the substrate 400 is obtained based on a template corrected based on the tilt information (α, γ) of the measured plane 400a and the projection image.

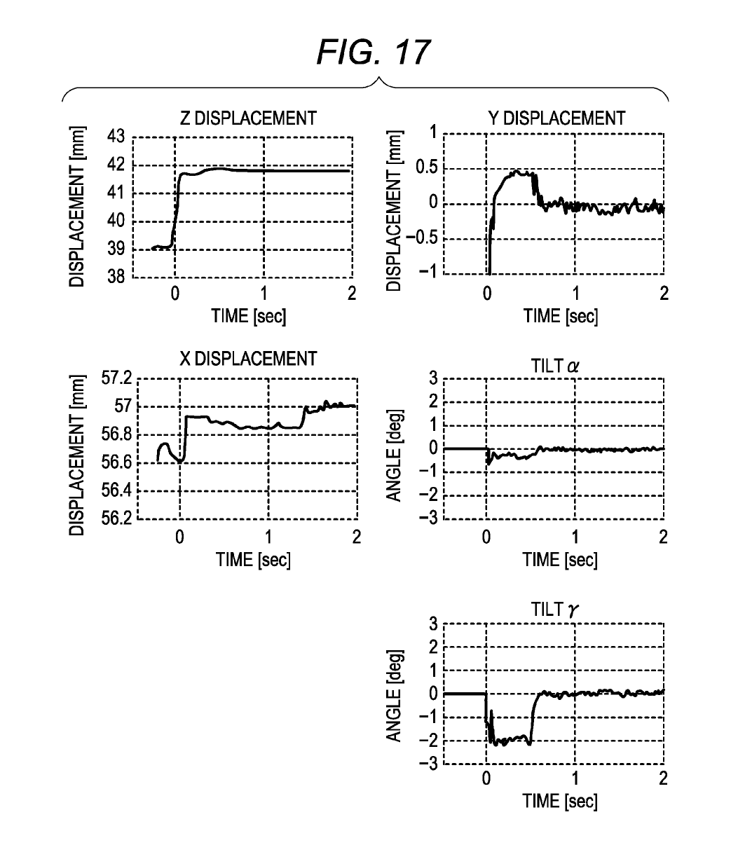

The distance measuring unit and the imaging unit continuously obtain the measurement information, and the six-degree-of-freedom information calculation part 1220 continuously calculates the position information of the substrate 400. FIG. 17 shows a portion of the information of the X, Y, and Z displacements and the tilts α and γ continuously obtained. According to the first displacement sensor 1110 of the present embodiment, the position information at an arbitrary position can be calculated.

Hereinafter, the position teaching process in the coating apparatus 1000, mainly in the supply robot 300 is described.

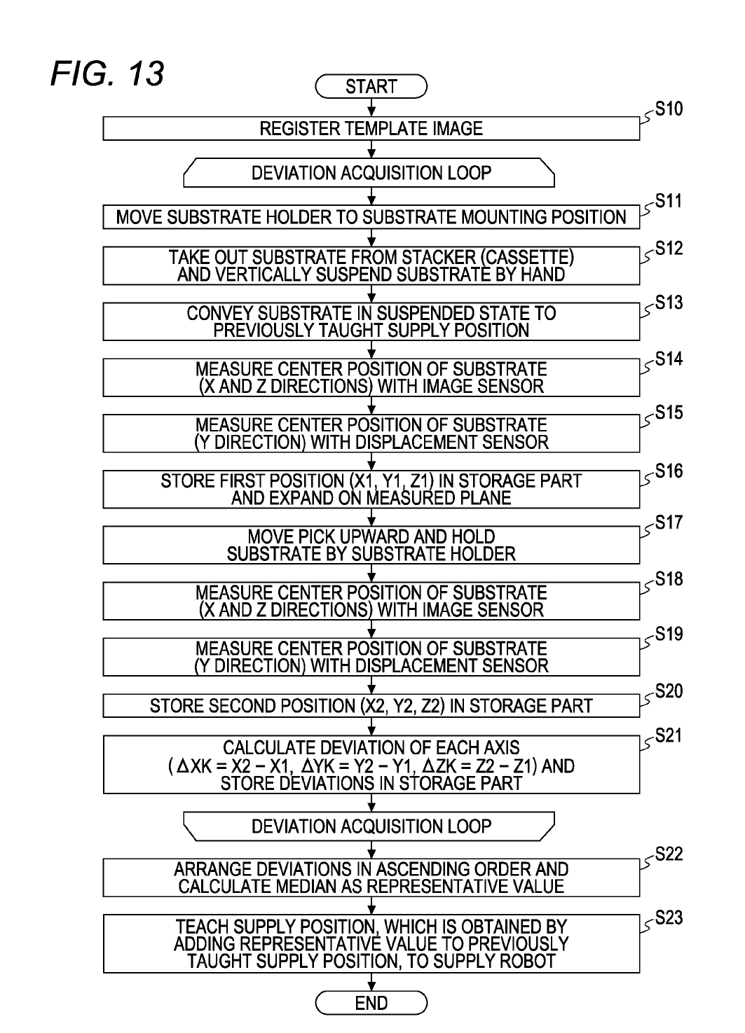

FIG. 13 is a flow diagram showing the position teaching method for the supply robot 300.

First, a template image of the substrate 400 is previously created to be stored in the template image storage part 1240 (S10).

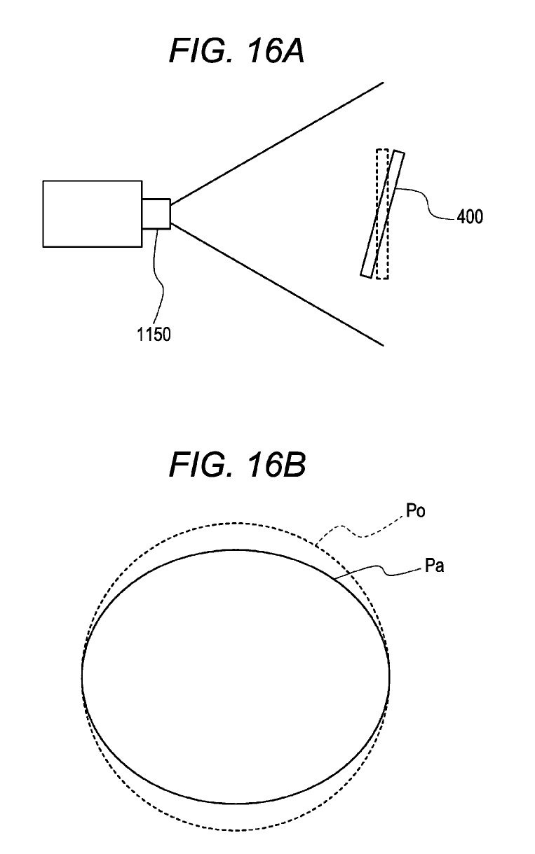

Subsequently, the flow enters a deviation acquisition loop, and the first substrate holder 200 is moved to a substrate mounting position. The supply robot 300 is instructed to take out the substrate 400 from the stacker containing the substrates, and a hole provided in the center of the substrate 400 is vertically suspended by the pick 320 of the supply robot 300. The substrate 400 in the suspended state is conveyed to the supply position previously taught by an operator. The supply position may be the supply position used before attachment of the substrate holder 200 to the conveyance mechanism. The center position of the substrate 400 at that position is calculated by using the measurement result from the first to third displacement sensors 1110 to 1130 and the image sensor 1150. At that time, if the substrate 400 tilts, an image obtained from the image sensor 1150 is a projection image Pa having a distorted shape with respect to an actual shape Po, as shown in FIG. 16B. The projection image Pa and the template are matched, and consequently the substrate center position is obtained. At that time, the template is corrected based on the tilt information (α, γ).

The data of the substrate center position (X1, Y1, Z1) which is obtained as above and is the first position information is stored in the substrate position data storage part 1250 (S11 to S16).

Next, the pick 320 is moved upward by a predetermined distance, and the outer edge of the substrate 400 is pressed against the upper claws 210 and 220 of the substrate holder 200 and is then pressed against the lower claw 230, whereby the substrate 400 is held by the substrate holder 200. The pick 320 is moved downward by a predetermined distance to be removed from the hole of the substrate 400, and, thus, to be retracted to the position of taking out the substrate 400 from the stacker. The center position of the substrate 400 (X2, X2, Z2), which is in the state of being held by the substrate holder 200 (namely, in the state of being at the holding position), is obtained as in steps S14 and S15 to be stored as second position information in the substrate position data storage part 1250 (S17 to S20).

Based on the first and second position information stored in the substrate position data storage part 1250, the deviation of each axis therebetween is calculated. Namely, ΔXk=X2−X1, ΔYk=Y2−Y1, and ΔZk=Z2−Z1 are calculated. The calculated deviations ΔXk, ΔYk, and ΔZk are stored in the substrate position data storage part 1250 (S21).

Steps S11 to S21 are applied to all the substrate holders 200. Thereafter, the respective deviations with respect to the substrate holders 200 stored in the substrate position data storage part 1250 are arranged in the ascending order, and the median as the representative deviation value is calculated by the above method. The obtained median is added to the supply position taught by the operator in S130, and this value as a new supply position is taught to the robot controller 1260 (S22 and S23).

According to the above, the position with the smallest variation between the supply position and the holding position with respect to the substrate holder 200 can be automatically calculated to be taught to the supply robot 300.

Here, the position teaching program 1230 is described. The position teaching program 1230 is constituted of program modules including a substrate position measuring part 1231, a representative deviation calculation part 1232, and a teaching part 1233. The outlines of those program modules are described.

The substrate position measuring part 1231 obtains the position information where the substrate 400 is at the supply position and the holding position with the image sensor 1150, the image information of the template image storage part 1240, and the first displacement sensor 1110, the second embodiment sensor 1120, and the third displacement sensor 1130. The positions of the substrates 400 are obtained while mounting these substrates 400 to a plurality of the substrate holders 200 and storing the positions in the substrate position data storage part 1250.

The representative deviation calculation part 1232 calculates the deviations from the supply position and the holding position of the substrate 400 stored in the substrate position data storage part 1250 to calculate the representative deviation from the obtained deviations.

The teaching part 1233 calculates the supply position based on the representative deviation obtained by the representative deviation calculation part 1232 to teach the representative deviation to the robot controller 1260.

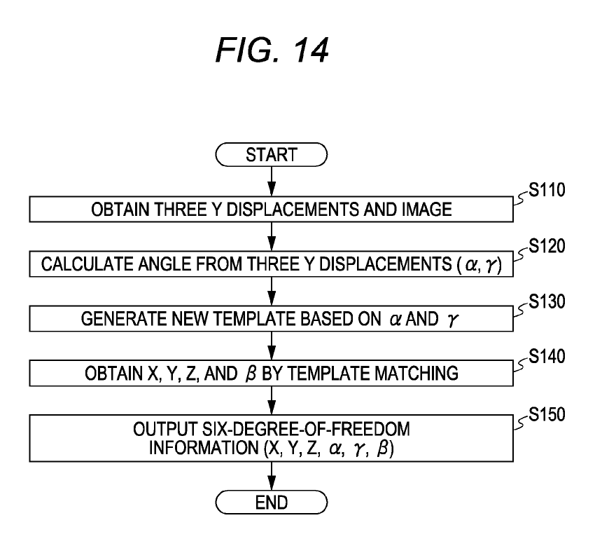

FIG. 14 shows a specific flow obtaining the measurement value stored in the substrate position data storage part 1250. In step S110, the Y displacements with respect to the three measurement points 400a1, 400a2, and 400a3 are obtained, and, at the same time, obtains the projection image. The projection image Pa at the time when the substrate 400 tilts has an elliptical shape as shown in FIG. 16.

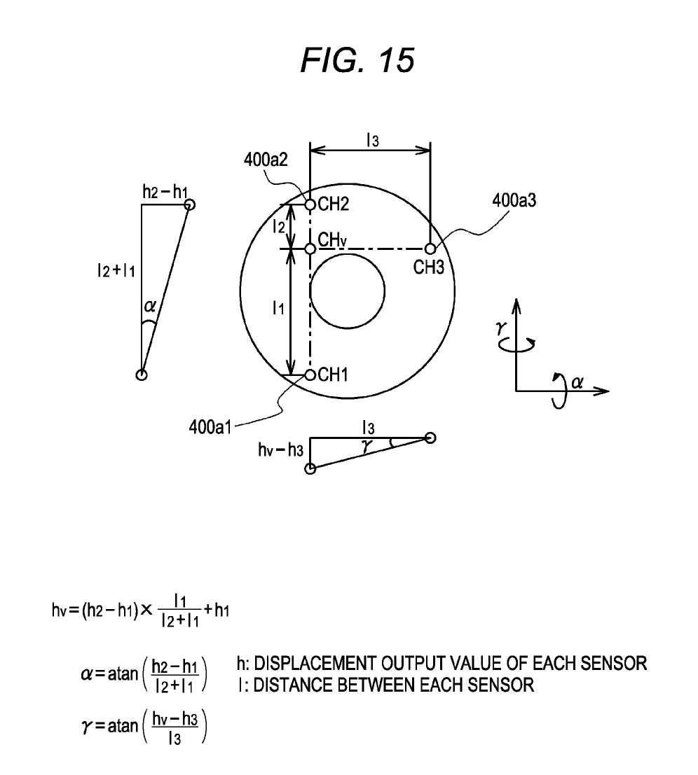

After the processing of step S110, as shown in FIG. 15, the tilts α and γ are calculated (step S120). At that time, the position of CHv is calculated with a measurement value h1 of the first displacement sensor 1110 and a measurement value h2 of the second displacement sensor 1120 which are the measurement values in the Y direction. The tilts α and γ are calculated with the measurement values h1, h2, and h3 and the calculated hv. The calculation is performed in the angle calculation part 1180.

Next, in step S130, a template stored in the template image storage part 1240 is corrected based on the tilts α and γ. The correction is performed in the error correction part 1190, and a new template is generated in the template generation part 1200. The generated template is sent to the image processing calculation part 1210. The projection image obtained by the image acquisition part 1160 is also sent to the image processing calculation part 1210.

After the execution of the processing of step S130, the flow proceeds to step S140. In step S140, template matching is performed. Then, measurement values X, Y, Z, and β are calculated by the template matching.

The six-degree-of-freedom information is obtained by passing through the above process (S170).

The template matching is performed as follows.

In the template matching, a prepared template image and an image obtained from the imaging unit are overlapped with each other to calculate the similarity, and the position showing the highest similarity is searched while the position of the template image is moved, whereby the position of a desired portion is obtained. Although various specific methods of template matching are proposed, the most basic method is as follows.

First, the template generated by the template generation part 1200 is registered on the image processing calculation part 1210. In order to reduce the processing time and the influence of noise, ROI (Region of interest) is set. The template is a template image M of the substrate 400 obtained by taking out a doughnut-shaped region that is surrounded by two circles larger and smaller than the outer circumferential circle of the substrate 400.

Next, a projection image I (i, j) obtained by the image processing calculation part 1210 and a template image M (i, j) are compared with each other, and the most coincident position is searched from the projection image.

$$k ( a , b ) = \frac{{\sum }_{( i , j ) ∈ R} \sum I ( i , j ) M ( i - a , j - b )}{\begin{matrix}\sqrt{{\sum }_{( i , j ) ∈ R} \sum \{ I ( i , j ) \}} \\ \sqrt{{\sum }_{( i , j ) ∈ R} \sum \{ M ( i - a , j - b} ) \}\end{matrix}} \qquad ( Formula 1 )$$

(a, b) represents a scanning position, and a and b are respectively shifted by one pixel to obtain the similarity (correlation value) at each position in the scanning of the template image on the projection image. (a, b) with the largest similarity is the center position of the substrate 400. When the radius of a circular template is r, the detected center position of the substrate 400 is (a+r, b+r).

In the present embodiment, the deviation between the supply position when the substrate 400 is supplied to the substrate holder 200 by the supply robot 300 and the holding position when the substrate 400 is held by the substrate holder 200 is obtained. A method for calculating the deviation is described. In the following example, the deviation in the X-axis direction is obtained; however, the deviations in other axes can be obtained by the similar method.

When the substrate 400 is pressed against the upper claws 210 and 220, the center of the substrate 400 is moved from the supply position to the holding position, and the deviations (Δx and Δz) are generated. Although it is ideal that the deviation amounts in all the substrate holders 200 are zero, the deviation amounts are varied due to an assembly error in the attachment of the upper claws 210 and 220 to the substrate holder 200.

The deviation ΔXₖ of a substrate holder k is calculated by formula (2).

ΔXₖ=X₂−X₁ (Formula 2)

After the supply position is taught by an operator, the deviation amounts of all the substrate holders 200 are calculated by the formula (2), and the variation distribution of the deviations is obtained.

Then, the median is determined as a representative value ΔXᵣso that positive and negative variation distributions based on the supply position are the same in number. When the number of the substrate holders is N, the deviations ΔXₖ are arranged in the ascending order. Namely,

ΔX⁽¹⁾≦ΔX⁽²⁾≦ . . . ≦ΔX^{(N)} (3).

At that time, the median ΔXr is given by the following formula (4).

When the total number N of the substrate holders is an even number:

$$Δ {X}_{r} = \frac{Δ {X}^{( N / 2 )} + Δ {X}^{( N / 2 + 1 )}}{2} \qquad ( Formula 4 )$$

When the total number N of the substrate holders is an odd number:

ΔXᵣ=ΔX^{(N+1/2)} (Formula 5)

The median ΔXᵣ calculated as above is first added to the teaching position originally given from the operator, whereby the teaching position is corrected. Thereafter, the median ΔXᵣ added to the teaching position originally given from the operator is taught to the robot controller 1260.

Since the coating apparatus 1000 of the present embodiment is provided with the position measuring apparatus 1100, the position information of the substrate 400 as an object can be obtained with high accuracy by measurement from one direction. Further, an optimum teaching position can be calculated by utilizing the position information.

The substrate 400 is placed on the optimum teaching position, and consequently it is possible to prevent the coating apparatus 1000 from being stopped due to a reduction of the yield and a drop of the substrate.

In the position measuring apparatus 1100, in the coating apparatus 1000 under operation, substrate posture change in the substrate holding process is measured for each substrate holder, whereby the substrate holder 200 which seems to be clearly abnormal relative to the trend of the previous holder can be specified. The substrate holder 200 determined as abnormal can be removed and exchanged. According to this constitution, the frequency of stopping the apparatus due to the reduction of the yield and the drop of the substrate can be reduced.

Further, in the position measuring apparatus 1100, in the coating apparatus 1000 under operation, the substrate posture change in the substrate holding process is measured for each substrate holder, whereby the substrate displacement amount around the holding claw such as the upper claw 210 can be calculated from an in-plane rotation degree of freedom of the obtained substrate posture, that is, five-degree-of-freedom information except for the tilt β. The displacement amount can be regarded as a sliding amount of the substrate 400 causing peeling of a film-formation layer deposited on the upper claw 210. When the sliding amount increases, the substrate holder 200 is exchanged, or the teaching position is corrected by the supply robot 300, whereby the reduction of the yield can be prevented.

Further, the distance measuring unit and the imaging unit of the position measuring apparatus 1100 of the present embodiment continuously obtain the measurement information as some measurement values are shown in FIG. 17, and the six-degree-of-freedom information calculation part 1220 continuously calculates the position information of the object to store the position information. Therefore, the position information can be obtained at an arbitrary timing. The stored information can be analyzed in an ex-post manner.

Here, an example in which the accuracy of the position detection can be further enhanced is described. The first displacement sensor 1110, the second displacement 1120, and the third displacement sensor 1130 are sensors using the laser beam. The measurement using a triangulation method with those sensors is described.

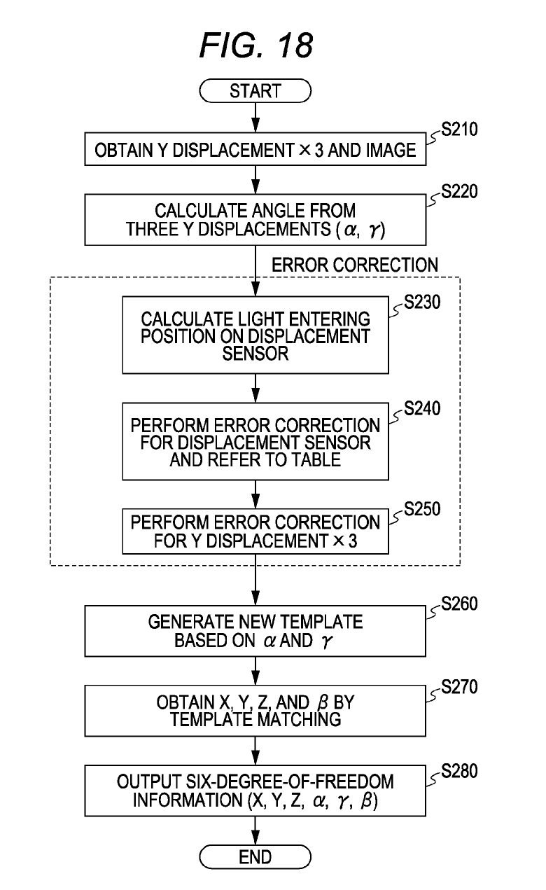

FIG. 18 is a flow diagram of the position measurement process for the substrate 400 when the triangulation method is used.

Compared with the flow diagram shown in FIG. 14, the processing from steps S230 to S250 is added. Namely, the processing of steps S210 and S220 is the same as the processing of steps S110 and S120 of FIG. 14. The processing from steps S260 to S280 is the same as the processing from steps S130 to S150 of FIG. 14.

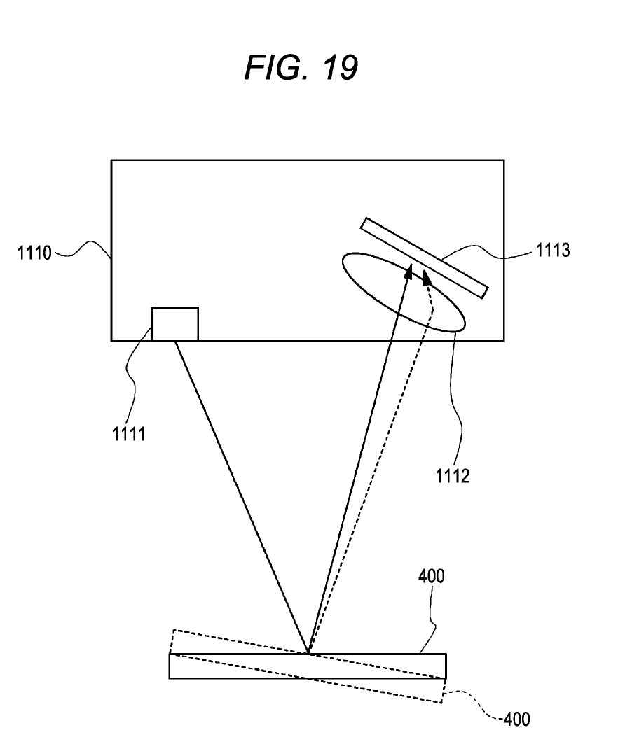

In the displacement sensor which measures the displacement with a laser beam by using the triangulation method, the reflected light of the applied laser beam is collected through a light receiving lens 1112 as shown in FIG. 19, and the peak of a light reception amount is detected by a detection device 1113 to output the displacement. When a measured object is not a mirror surface, the reflected light becomes diffusion light; therefore, strong reflected light is less likely to be received, and light reception peak variation caused by the angle change of the measured object is small. However, when the measured object is a mirror body like the substrate 400, the reflected light is specular; therefore, the light reception peak is varied due to the influence of strong reflected light, leading to output of a displacement including error. As shown in FIG. 19, since the measurement error in the specular measurement arises from aberration of the light receiving lens 1112, the amount of error is uniquely determined by a light entering position on the light receiving lens 1112.

The amount of generation of error attributable to the angle change can be experimentally obtained, and if the light entering position can be specified, error correction can be performed.

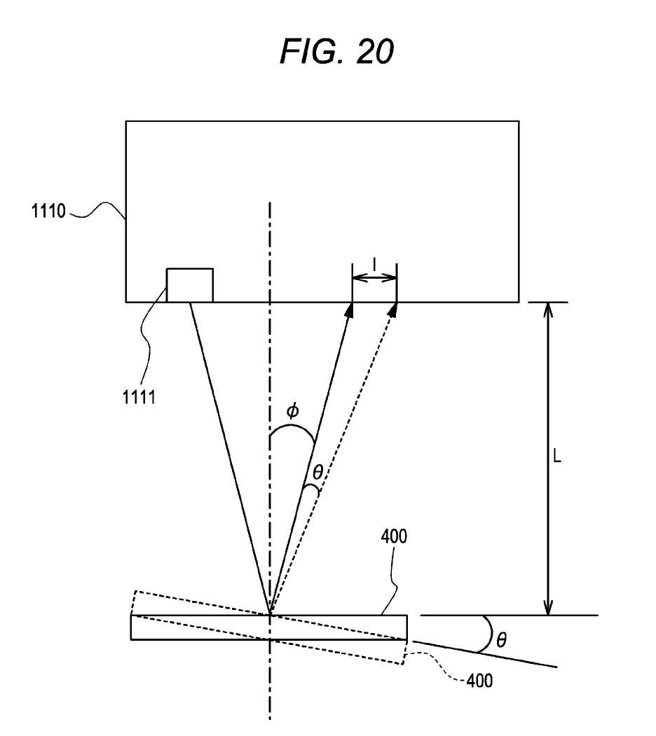

The variation of the light entering position is calculated by the following formula from an angle change amount θ of FIG. 20 calculated from the measurement result and geometric installation conditions:

A light entering position variation I=L×tan(Φ+θ)−L×tan(Φ)

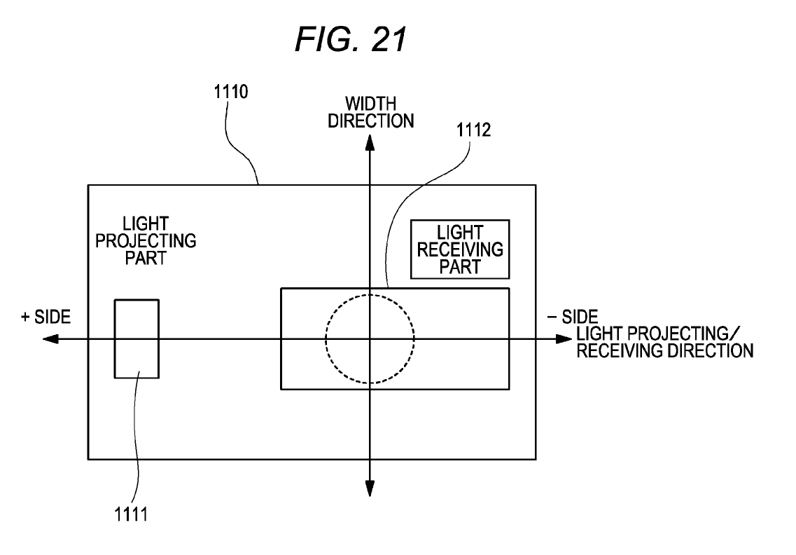

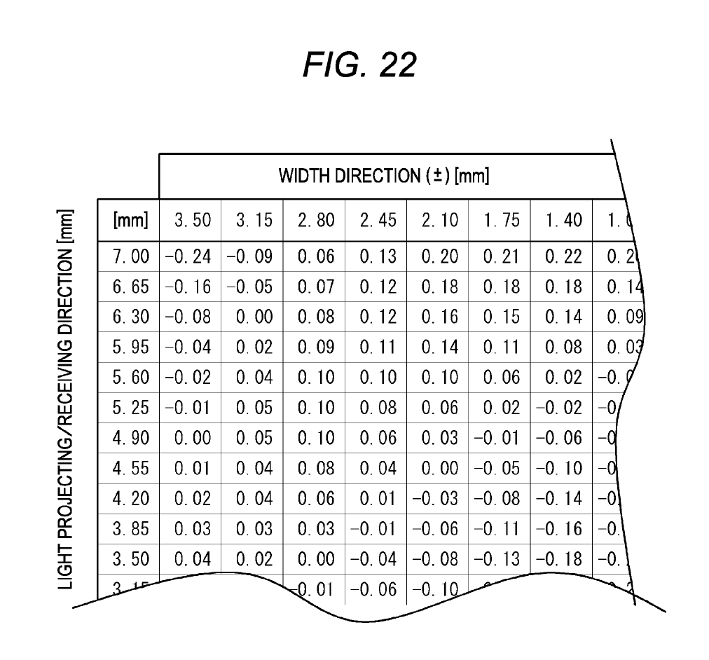

FIG. 21 is an explanatory view of a position coordinate in a light receiving window of the head of the displacement sensor 1100. FIG. 22 shows an example of a table collecting correction values based on a specularly reflected light position for the light receiving window.

When the position measurement is performed based on the flow diagram of FIG. 18, the light entering position variation I is calculated by the above formula in step S230. The table shown in FIG. 22 is referred to in step S240, and the error correction for the displacement sensor is performed in step S250. The processing is applied to the Y displacements of the first displacement sensor 1110, the second displacement 1120, and the third displacement 1130. Thereafter, final six-degree-of-freedom information is obtained with the measurement values of the corrected Y displacements (S260 to S280).

The above error correction processing is performed, and consequently the position measurement with higher accuracy can be performed.

1. A position measuring apparatus comprising:
a distance measuring part which obtains at least three pieces of distance information between at least three measurement points on a measured plane of an object and a displacement sensor;
an imaging part which generates a projection image on the measured plane of the object; and
a calculating part which obtains tilt information of the measured plane based on the at least three distance information pieces and obtains position information of the object based on the tilt information and the projection image.

2. The position measuring apparatus according to claim 1, wherein the distance measuring part has at least three displacement sensors corresponding to each of the measurement points, and the optical distances between the respective displacement sensors and a specific plane are the same as each other.

3. The position measuring apparatus according to claim 1, wherein the calculating part calculates the tilt information of the measured plane based on the distance information and obtains the position information of the object based on a template, which is corrected based on the tilt information, and the projection image.

4. A coating method for a substrate, comprising the steps of:
mounting a substrate holder to the substrate by means of a supply robot;
obtaining at least three pieces of distance information from at least three measurement points on a measured plane of the substrate and a displacement sensor;
generating a projection image of the measured plane of the substrate;
obtaining tilt information of the measured plane based on the at least three distance information pieces;
obtaining position information of the substrate based on the tilt information and the projection image;
moving in sequence the substrate mounted with the substrate holder to a plurality of film-formation chambers and applying film formation to the substrate in each of the film-formation chambers;
removing the substrate after completion of the step of applying film formation from the substrate holder; and
by means of the supply robot, based on the position information, correcting a mounting position of the substrate holder to be mounted to a new substrate.

5. The coating method according to claim 4, wherein the distance measuring device has at least the three displacement sensors, and the optical distances between the respective displacement sensors and a specific plane are the same for each displacement.

6. The coating method according to claim 4, wherein the tilt information of the measured plane in the direction of deviating from a vertical virtual plane is calculated based on the distance information, and position information of the substrate is obtained based on a template, which is corrected based on the tilt information of the measured plane, and the projection image.

7. A coating apparatus comprising:
a supply robot which mounts a substrate holder to a substrate;
a plurality of film-formation chambers which apply a film-formation processing to the substrate held by the substrate holder;
a distance measuring part which obtains at least three pieces of distance information between at least three measurement points of the substrate and a displacement sensor;
an imaging part which generates a projection image of the substrate;
a calculating part which obtains tilt information of a measured plane based on the at least three distance information piece and obtains position information of the object based on the tilt information and the projection image; and
a position teaching part which makes the supply robot correct a mounting position of the substrate holder to be mounted to a new substrate based on the position information.
